(19) United States
(12) Patent Application Publication
(10) Pub. No.: US 2004/0055969 A1
(43) Pub. Date: Mar. 25, 2004

(54) Water treatment system and method

(76) Inventor: Michael Barnes, Oceanside, CA (US)

Correspondence Address: Greg J. Michelson, MacPHERSON KWOK CHEN & HEID LLP, Suite 210, 2402 Michelson Drive, Irvine, CA, 92612, US

(21) Appl. No.: 10/255,262

(22) Filed: Sep. 25, 2002

(51) Int. Cl. C02F 1/78

(52) U.S. Cl. 210/760; 210/764; 210/205

(57) ABSTRACT

A water treatment system and method are provided that comprehensively treats a body of water. A mixing apparatus receives ozone gas, a chemical composition, and contaminated water to form a mixture and thus oxidize, balance, disinfect, and kill algae in the water. A high level of ozone flow is used in the system to treat the water in a highly concentrated environment of ozone and chemical composition. Undissolved ozone is separated from the mixture and recirculated to efficiently use ozone while advantageously preventing or minimizing the venting of ozone from the system.

### BACKGROUND

1. Field of Invention

The present invention generally relates to treatment of water, and more particularly, to a system and method to purify, clarify, and/or stabilize water, such as for swimming pool, spa, hot-tub, or other circulating water systems.

2. Related Art

Safe and clean water is important in municipal, industrial, and recreational applications. Particularly in applications where water is intended for human contact or consumption, the water must be treated so that it is pleasant in terms of taste, color, turbidity, odor, and pH, and also environmentally safe and effectively free of pathogens and chemicals that can cause illness.

Water treatment usually entails chemical activity in four areas: 1) balance; 2) oxidation; 3) algaecidation; and 4) disinfection. Balance requires that the pH, total alkalinity, and calcium hardness of the water be kept within specified ranges to ensure non-corrosive water as well as the efficiency of other pool chemicals. Oxidation requires that the organic matter in the pool be thoroughly oxidized to maintain clarity and help in proper disinfection. Algaecidation requires that algae be effectively controlled to ensure clear and odor-free water. Finally, disinfection requires low or non-existent levels of harmful bacteria in the water.

Conventional methods use different chemicals to control these different areas of water treatment. Typically, the chemicals are added to the water separately as part of an overall water maintenance or purification program. The water is monitored on an hourly, daily, or weekly basis, and when a particular treatment parameter is not acceptable or in compliance with regulatory levels, the appropriate amount of the necessary chemical is added. Often, treatment of one water quality parameter causes another water quality parameter to change. Conventional treatment, therefore, employs a continuous balancing process of monitoring water quality parameters and dosing with various chemicals to create and to maintain the appropriate water quality.

A minimum disinfectant level must be maintained in order to meet requirements such as residential pool and spa sanitation requirements. Chlorine, bromine, and ozone are well-known disinfectants used to treat water but chlorine is disfavored because the chemical tends to have a detrimental effect on water balance, cause eye irritation, and have an odor. Furthermore, in many cases, chlorine does not provide enough oxidation or algae control, thus requiring shock treatment of the water and supplemental algaecides, resulting in multiple treatment procedures. Thus, an all-in-one system and method that simply and comprehensively treats a body of water is desirable.

Ozone dissolved in water advantageously degenerates or causes lysis of cell walls of bacteria, viruses, protozoan organisms, algae and other microbiota, thereby serving as a very effective disinfectant. Furthermore, water having dissolved ozone gas therein has other benefits. For example, ozone rapidly reacts with metal ions (e.g., iron and manganese) within the water, forming precipitants which may be removed through filtration, thereby effectively “softening” the water.

In order for ozone gas to have a purifying effect upon the water, such gas must be dissolved into the water. Dissolution of ozone gas into the water occurs at the spherical surface tension boundaries between the gas and the water over time.

One problem with indoor pools, spas, hot tubs, jetted bathing facilities and other similar immersion facilities that utilize ozone for sanitization purposes is outgassing of the undissolved ozone into the area surrounding the facility. Strict rules have been enacted that require that outgassing of ozone from such a facility not exceed 0.1 ppm. Thus, it is desirable that little or no ozone be allowed to escape during a water treatment process.

Therefore, what is needed is a water treatment system and method that comprehensively treats a body of water by balancing, oxidizing, disinfecting, and controlling algae in an efficient and simple manner with minimal or no venting of ozone to the ambient atmosphere.

### SUMMARY

The present invention provides a system and method for comprehensively treating a body of water simply and efficiently.

In one embodiment of the present invention, a water treatment system comprises an ozone generator adapted to generate ozone, a mixer, coupled to the ozone generator, adapted to mix the ozone with water to form a mixture, and a separator, coupled to the ozone generator and the mixer, adapted to separate the undissolved ozone from the water and return the undissolved ozone to the ozone generator.

In another embodiment of the present invention, a water treatment system comprises ozone generating means for producing ozone, mixing means for mixing ozone with water, the mixing means being coupled to the ozone generating means, and separating means for separating ozone from the water to return the separated ozone to the ozone generating means, the separating means being coupled to the ozone generating means and the mixing means.

In another embodiment, a water treatment system comprises a mixing apparatus capable of receiving ozone gas, a chemical composition, and water to be treated to form a mixture, a separation apparatus operably coupled to the mixing apparatus to separate undissolved ozone gas from the mixture, the undissolved ozone gas being recirculated, and a pump to pull and discharge water mixed with or to be mixed with the ozone gas and the chemical composition.

In yet another embodiment of the present invention, a water treatment method comprises generating ozone gas, dispensing a chemical composition, mixing the generated ozone gas and the dispensed chemical composition with water to form a mixture, separating undissolved ozone gas from the mixture, and recirculating the undissolved ozone gas to prevent ozone venting.

Advantageously, the present invention allows for comprehensive and efficient treatment of contaminated water by balancing, oxidizing, disinfecting, and controlling for algae with minimal or no venting of ozone.

This invention will be more fully understood in light of the following detailed description taken together with the accompanying drawings. The scope of the invention is defined by the claims, which are incorporated into this section by reference.

### BRIEF DESCRIPTION OF DRAWINGS

FIG. 1 shows an illustration of the outer components of one example of a water treatment system in accordance with an embodiment of the present invention.

FIG. 2 shows a flow diagram of a water treatment system in accordance with one embodiment of the present invention.

FIG. 3 shows a flow diagram of a water treatment system in accordance with another embodiment of the present invention.

FIGS. 4A-4E show different perspective views of a dispenser housing in accordance with an embodiment of the present invention.

FIGS. 5A-5C illustrate an example of an indicator system and related circuitry in accordance with an embodiment of the present invention.

FIGS. 6A-6B show different perspective views of a dispenser cartridge in accordance with an embodiment of the present invention.

Use of the same reference symbols in different figures indicates similar or identical items. It is also noted that the figures are not drawn to scale.

### DETAILED DESCRIPTION

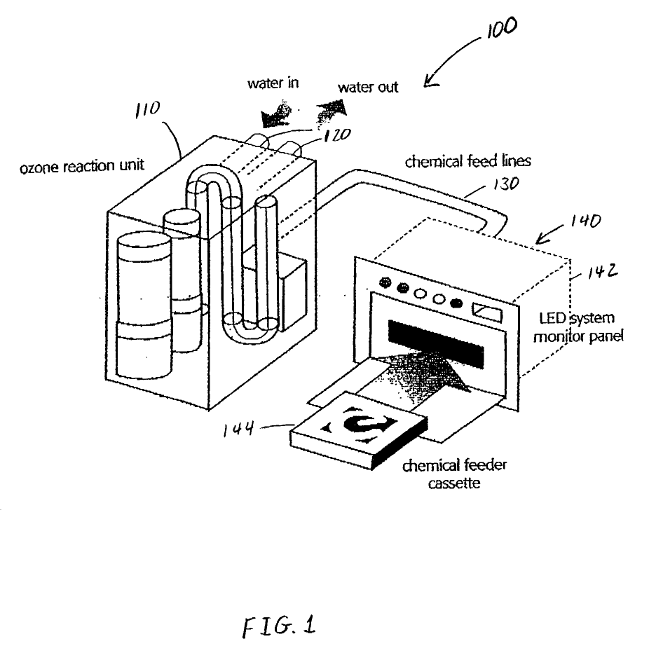

FIG. 1 illustrates a water treatment system 100 in accordance with an embodiment of the present invention. As shown in FIG. 1, a portion of water treatment system 100 may be, but not necessarily, constructed with or housed within a casing 110, with access thereto provided by making one or more sidewalls removable. Such a casing 110, for example, may be rectangular or square, as seen from a side, and relatively narrow in width so as to be conveniently mountable within a spa or hot tub enclosure. In one example, casing 110 has a width of about 12 inches, a height of about 18 inches, and a depth of about 9 inches. Casing 110 may be made of a durable, rigid, and/or water-resistant material, such as a rust-resistant metal or a hard plastic, but any applicable material may be used to make the compartment in accordance with the present invention.

Water lines 120 extend out of casing 110 and operably connect to a body of water (not shown) so as to allow water to enter and exit treatment system 100. Water lines 120 may comprise PVC piping, ¾ inch barbed fittings, and/or hosing in one example, but any applicable material and structure that allows the transfer of water may be used to operably connect to a body of water in accordance with the present invention.

As further shown in FIG. 1, a chemical dispenser apparatus 140 may be a separate assembly from that portion of water treatment system 100 housed within casing 110. In one example, chemical dispenser apparatus 140 includes a dispenser housing 142 that receives a dispenser cartridge 144, which holds a chemical composition to treat the water. Chemical dispenser apparatus 140 is operably connected to the portion of water treatment system 100 enclosed in casing 110 via chemical feed lines 130. Chemical feed lines 130 may comprise ¼ inch flexible polymer tubing in one example. In other embodiments, chemical dispenser apparatus 140 may be operably configured into casing 110 with appropriate connections to the rest of the system and appropriate access to dispenser apparatus 140 such that treatment system 100 is fully housed in a single enclosure.

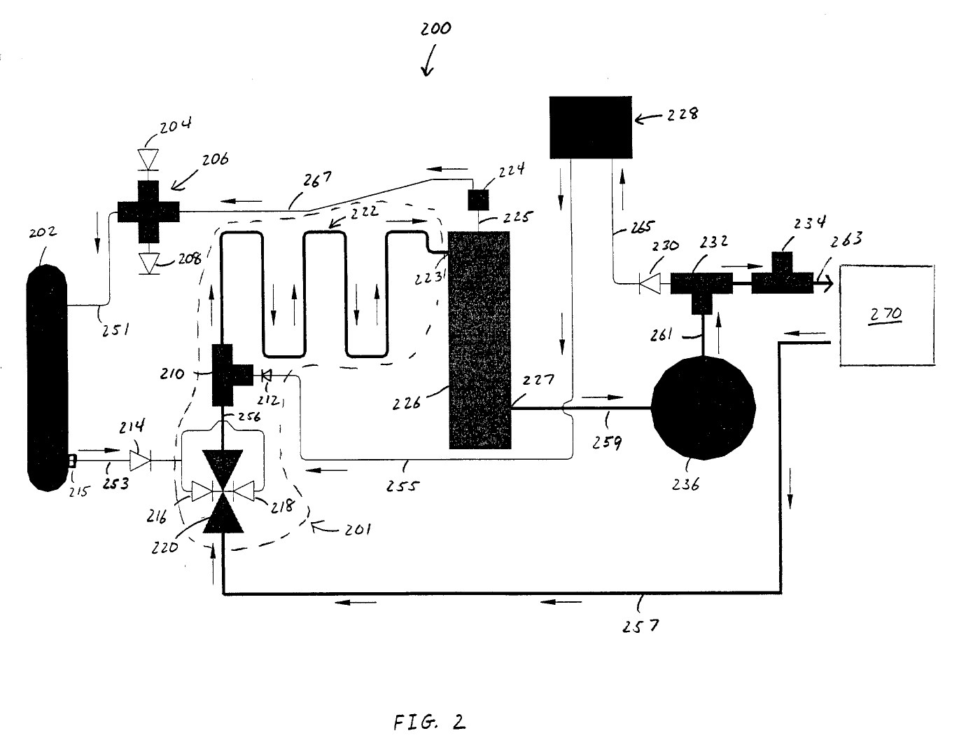

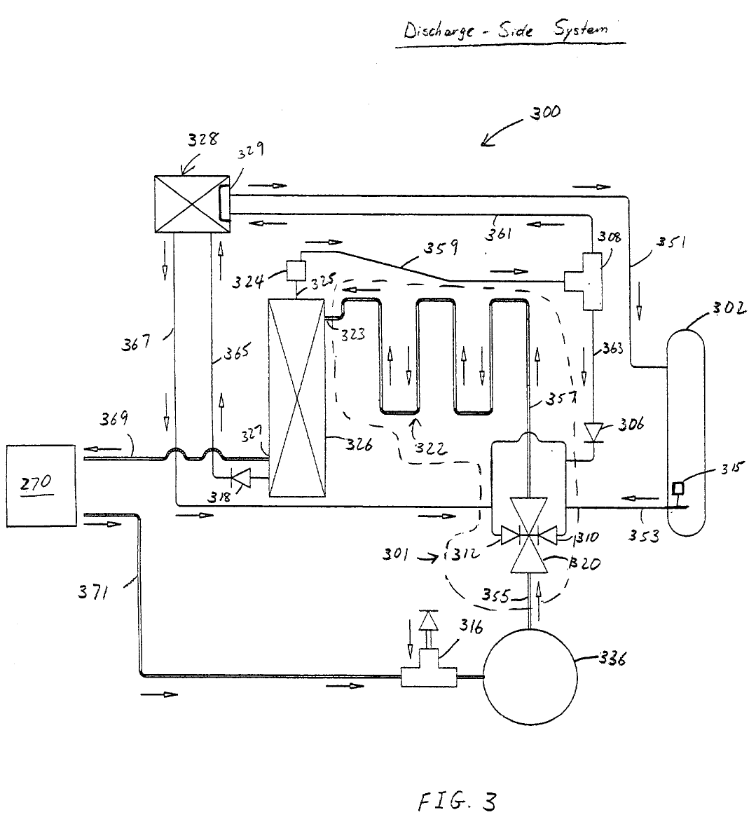

FIGS. 2 and 3 show flow diagrams of two exemplary embodiments of water treatment system 100 (FIG. 1). As shown in FIG. 2, system 200 includes a mixing apparatus 201 (enclosed by dashed lines) which receives ozone gas from an ozone generator 202, a chemical composition from chemical dispenser apparatus 228, and water to be treated from a body of water 270. Because the ozone is in the form of a gas and the chemical composition is in the form of a solid, both need to be dissolved in the water for treatment to take place. In one example, mixing apparatus 201 may include a venturi 220, a T-valve 210, or a mixing line 222, individually or in different combinations. However, the invention is not limited to the aforementioned components and any mixing apparatus may be used that can receive and mix together solution and gaseous materials in accordance with the present invention.

One particular body of water 270 may be hot-tub water, but the present invention is not limited to such an example and may include swimming pool water, whirlpool water, fountain water, or any other body of water that is desired to be treated. The ozone gas, chemical composition, and water are mixed together prior to the mixture being circulated back to body of water 270.

Ozone which is used to treat the water from body of water 270 is generated by ozone generator 202. Ozone generators may comprise a cylindrical chamber through which atmospheric air containing diatomic oxygen is pumped or drawn, optionally by using an air compressor or similar device. Radiation from a lamp emits intense ultraviolet light at wavelengths that excite the diatomic oxygen within the chamber. As a result of such molecular excitation, a fraction of the diatomic oxygen within the chamber is split, producing free atoms of oxygen. The extremely high chemical reactivity of free oxygen atoms within the chamber causes them to rapidly react with the remaining intact oxygen, forming ozone gas (O₃).

Another commonly known method of producing ozone gas within a chamber is to install closely spaced electrodes therein and to apply a sufficiently high electrical potential between the electrodes to produce electric discharge arcing (e.g., corona discharge). Diatomic oxygen molecules in close proximity with such electrical arcing similarly degrade into free oxygen atoms, which quickly react with diatomic oxygen to form ozone.

Thus, ozone generator 202 may include an ultraviolet light ozone generator, a corona discharge ozone generator, or any applicable ozone generator in accordance with the present invention. In accordance with the present invention, water is treated in a highly concentrated environment of ozone for effective water treatment. In one example, ozone generator 202 produces between about 500 ppm and about 600 ppm of ozone to treat between about 450 gallons and about 550 gallons of water. An air flow of between about 1 cubic foot per hour and about 5 cubic feet per hour may be used through a cross-section between about 2 inches and about 3 inches in diameter with power input between about 300 milliamperes and about 600 milliamperes. Advantageously, an ozone sensor 215 may be used in conjunction with ozone generator 202 to gauge that a sufficient amount of ozone is being produced by ozone generator 202 for maximum and efficient treatment of water within required guidelines. It will be apparent to those of ordinary skill in the art that different amounts of ozone will need to be generated to treat different sizes of bodies of water.

The chemical composition which eventually mixes with ozone and water may be used to balance, oxidize, disinfect, or control algae in the water. Exemplary chemical compositions, which may be used in accordance with the present invention, are disclosed in U.S. Pat. No. 6,120,698, issued Sep. 19, 2000, and in related U.S. Pat. No. 6,149,821, issued Nov. 21, 2000, which are incorporated by reference herein in their entirety.

An example of a chemical composition which is disclosed in these patents include a buffer compound having an acidic component and a basic component, the acidic and basic components being present in amounts such that the molar ratio of the acidic component to the basic component yields a buffer compound whose pH in solution corresponds to the predetermined pH of the water to be treated, a biocide compound present in an amount sufficient to inactivate the microorganisms in the water to be treated, and an oxidizer/clarifier compound present in an amount sufficient to oxidize the biocide precursor completely. The acidic component includes, but is not limited to, sodium bisulfate. The basic component includes, but is not limited to, sodium bicarbonate and sodium carbonate. In one example, the molar ratio of sodium bisulfate to sodium bicarbonate is between about 0.26 to about 0.14, corresponding to buffer compound pH in solution from about 6.8 to about 7.2. The biocide compound includes, but is not limited to, ammonium chloride, ammonium bromide, or sodium bromide. The oxidizer/clarifier compound includes, but is not limited to, a peroxide, alkali metal perborate, or alkali metal persulfate. The chemical composition may also include an algaecide, a chelating agent, therapeutic minerals, stain and scale inhibitors, a calcium releasing compound, or a sequestering agent, individually or in any combination. In the alternative, a chemical composition may exclude the oxidizer/clarifier compound. It is noted that the chemical composition is not limited to the aforementioned examples but may include a variety of chemical compositions that can be used to balance, oxidize, disinfect, or control algae in the water.

Referring again to FIG. 2, venturi 220 draws ozone-enriched air from ozone generator 202 through line 253 and valves 214, 216, and 218, in one example. In one example, valve 214 is rated at 6 pounds per square inch (psi), and valves 216 and 218 are floaters and/or diaphragms.

An applicable venturi 220 which may be used is a multi-port venturi with a water inlet and outlet through which a flow of motive fluid is pumped or drawn. The motive fluid is channeled through a short tube with a constriction in the middle, which causes an abrupt decrease in fluid pressure and a corresponding vacuum. The resulting suction draws ozone-enriched air from the ozone generator into the stream of motive fluid through injection ports and helps to efficiently mix ozone with the motive fluid. The water from body of water 270 is pulled or drawn through venturi 220 as the motive fluid. One example of a venturi 220, with no intent to limit the invention thereby, is a Mazzei™ Injector Model No. 684, available from Mazzei Injector Corporation, Bakersfield, Calif. The mixture of water and ozone then enters T-valve 210.

T-valve 210 receives the chemical composition in water from chemical dispenser apparatus 228 via line 255. The chemical composition solution is drawn into T-valve 210 by water flow from line 256. In one example, T-valve 210, with no intent to limit the invention thereby, may be simple three-way piping. In a further example, chemical dispenser apparatus 228 holds about 115 grams of chemical composition, and about 0.2 gallons per minute of chemical composition solution is received by T-valve 210 for treating a body of water of about 500 gallons. It will be apparent to those of ordinary skill in the art that different amounts of chemical composition will need to be used to treat different sizes of bodies of water. Advantageously, a configuration of T-valve 210 receiving the chemical composition and the water/chemical composition mixture moving through T-valve 210 as the motive fluid enhances mixing of chemical composition, ozone, air, and water to be treated.

The mixture of ozone, air, water, and chemical composition moves from T-valve 210 and through mixing line 222. Mixing line 222 allows for a sufficient length of time to achieve maximum diffusion and reaction of ozone and chemical composition into and with the water. In order for ozone dispersion to occur within mixing line 222, mixing line 222 must have a sufficient length, i.e., an ozone contact length. For example, the contact length of the tube may typically be between about 4 feet and about 8 feet and the tube diameter may typically be between about ½ inch and about 1 inch. The length may vary depending upon variables such as rate of flow within the tube, size of the tube diameter, turbulence, and water temperature. Sharp turns within the tube or turbulence-inducing baffles or screens installed within the mixing line may serve the function of breaking larger ozone-carrying bubbles into smaller bubbles, increasing the overall surface areas of the bubbles, increasing the rate the ozone dissolves into the water, and increasing the rate the chemical composition mixes with the water. In one example, mixing line 222 is a tube about 4½ feet long, having a diameter of about ¾ inch at the beginning of the line and about 1 inch at the end of the line, and containing five counter-current streams. It is noted that mixing line 222 may have various counter-current streams, optional static mixers or baffles, and need not have a uniform diameter.

After the water is treated in such an environment of high ozone and chemical composition concentrations, the treated water and excess ozone which did not dissolve moves to a separation apparatus 226 so that gas phase and liquid phase materials may be separated. An example of a separation apparatus that may be used is a bubble separator device commonly comprising a hollow cylinder having an upper liquid input port 223, a lower liquid output port 227, and an upper gas vent 225. The bubble separator device reduces the velocities of currents of liquid within the bubble separator to a rate slow enough to allow bubbles of gas to rise to the top of the bubble separator. The bubbles then emit through the gas vent in the ceiling of the bubble separator, rather than continuing to flow downstream through the liquid output. Preferably, the output flow of the bubble separator is adjusted to prevent over filling. Also preferably, a float valve or solenoid-controlled valve 224 is installed with the gas vent to assure that water will not escape from the system through the vent. One example of a separation apparatus 226, with no intent to limit the invention thereby, is piping of about 3 inches in diameter.

Ozone gas and air from separation apparatus 226 are recirculated back to ozone generator 202. Gas is released from separation apparatus 226 along line 267 through valve 224. As previously noted, valve 224 prevents moisture from entering line 267. In one embodiment, balance valve apparatus 206 balances the optimal amount of air required by ozone generator 202 by allowing air into the system automatically prior to recirculated gas entering ozone generator 202.

In one example, when pump 236 is in operation and regular flow of liquids and gas is occurring, valve 208 allows air into the system, utilizing pressure differentials across the check valves and liquid-to-gas ratios in the lines, to make up for air that may be consumed during the ozone generation process. In one example, valve 208 is rated at 8 psi.

In one example, when pump 236 is not in operation and the system is idle, such as when chemical dispenser apparatus 228 is opened to replenish chemical composition, valve 204 may release traces of gas from line 267 as the system resets. In one example, valve 204 is rated at ½ psi. In another embodiment, valve 224 and balance valve apparatus 206 may be combined into a single float valve apparatus (not shown) along line 267 and line 251 to prevent moisture from entering ozone generator 202 and to automatically balance the air. Advantageously, recirculation of the undissolved ozone gas from separation apparatus 226 allows for high concentrations of ozone to be more efficiently generated and used in the water treatment system.

A mixture of ozone and air, either balanced or not through balance valve apparatus 206, is then recirculated into ozone generator 202 through line 251. From there, the cycle begins again to produce ozone to be injected or drawn into venturi 220 through line 253. By utilizing such a recirculation system and method, ozone venting into ambient atmosphere is prevented or minimized and ozone is efficiently generated and utilized.

Water treated with dissolved ozone and chemical composition is pulled by pump 236 from separation apparatus 226 through line 259. Thus, the mixing of contaminated water with ozone and chemical composition is performed on the suction side of pump 236. Advantageously, because the treated water is pulled by pump 236 from separation apparatus 226, spitting of the mixture is prevented, thereby not wasting any treated water and keeping ozone generator 202 dry. One example of a pump 236, with no intent to limit the invention thereby, is a circulating pump, Model No. SM-909-NTW-26 ¾″, available from Laing Thermotech, Inc., San Diego, Calif.

Treated water is then discharged from pump 236 along (i.e., through) line 261 and may be routed directly to body of water 270 (e.g., a swimming pool, a whirlpool, or hot tub). Alternatively, a portion of treated water emitting from line 261 may be split to chemical dispenser apparatus 228 to create a feedback loop for enhanced water treatment. As shown in FIG. 2, an amount of treated water is split at T-valve 232 and sent through check valve 230 and line 265 to chemical dispenser apparatus 228 in order to transport chemical composition to T-valve 210 to begin the treatment cycle again. The rest of the treated water is sent through flowswitch valve 234 and back to body of water 270 through line 263. In one example, about 0.2 gallons per minute of treated water is sent through check valve 230 and to chemical dispenser apparatus 228 and about 4.3 gallons per minute of treated water is sent back to body of water 270.

Advantageously, flowswitch 234 and check valve 230 work in conjunction with the rest of the system to automatically control for idling of the system and replacement of chemical composition. During normal operation, in one example, line 261 has a line pressure of about 1½ pounds while check valve 230 requires about 6 pounds of pressure to open. Check valve 230 is balanced with the rest of the system, including separation apparatus 226 that is pulling vacuum of about 15 inches of mercury, to release about 0.2 gallons per minute of treated water to chemical dispenser apparatus 228. If the chemical composition needs to be replenished, a consumer may open an access door to chemical dispenser apparatus 228. Upon such opening of the access, the system is flooded with air. Consequently, check valve 230 will quickly close when vacuum is broken by opening of the access door, but check valve 212, which is a ½ pound valve in one example, will remain open to quickly drain chemical dispenser 228 of any fluid since separation apparatus 226 is pulling vacuum of about 15 inches of mercury in one example. Pump 236 will cavitate upon suctioning of air and flowswitch 234, which is operably connected to pump 236, will place pump 236 in an idle mode to automatically reprime the pump. The water flow through treatment system 200 will be stopped until chemical composition is replenished and the access to chemical dispenser 228 is closed, at which time flowswitch 234 will automatically engage pump 236 to start the system flow again.

It is noted that flowswitch 234 may be replaced by other electronic devices, such as vacuum switches, that can detect when the pump is operating in a cavitated mode to automatically reprime the pump. Advantageously, a consumer need not manually turn the system on or off but may simply open an access to chemical dispenser 228 for replenishing of chemical composition. In one example, chemical composition may be replaced on a time basis (e.g., once per week) or by measurement of chemical composition levels in the water.

FIG. 3 illustrates a water treatment system 300 in accordance with another embodiment of the present invention. In this embodiment, similar apparatus are used in different configurations as compared to the previous embodiment illustrated in FIG. 2. Similar chemical compositions may also be mixed with ozone and water to balance, oxidize, disinfect, or control algae in the water, as previously noted. It will be apparent to those of ordinary skill in the art that different amounts of chemical composition will need to be used to treat different sizes of bodies of water.

As shown in FIG. 3, water to be treated is pulled from body of water 270 by pump 336 through line 371 and an optional safety valve 316. One example of pump 336, with no intent to limit the invention thereby, is a circulating pump, Model No. SM-1212-NTW-36 ¾″, available from Laing Thermotech, Inc., San Diego, Calif. Safety valve 316 allows the suction of pump 336 to be bypassed, for example, in order to free any lodged material or person from the suction of pump 336.

In this embodiment, a mixing apparatus 301 (enclosed by dashed lines) includes a multi-port venturi 320 and a mixing line 322, but as noted previously, may include any applicable mixing device or devices individually or in combination in accordance with the present invention.

Venturi 320 receives ozone generated from an ozone generator 302 through a line 353 and valve 310, chemical composition from a chemical dispenser 328 through a line 367 and valve 312, and water to be treated through a line 355.

As previously noted, ozone generator 302 may include an ultraviolet light ozone generator, a corona discharge ozone generator, or any applicable ozone generator in accordance with the present invention. In one example, ozone generator 302 produces between about 500 ppm and about 600 ppm of ozone to treat between about 450 gallons and about 550 gallons of water. An air flow of between about 1 cubic foot per hour and about 5 cubic feet per hour may be used through a cross-section between about 2 inches and about 3 inches in diameter with power input between about 300 milliamperes and about 600 milliamperes. Advantageously, an ozone sensor 315 may be used in conjunction with ozone generator 302 to gauge that a sufficient amount of ozone is being produced by ozone generator 302 for maximum and efficient treatment of water within required guidelines. It will be apparent to those of ordinary skill in the art that different amounts of ozone will need to be generated to treat different sizes of bodies of water.

Referring again to FIG. 3, venturi 320 draws ozone-enriched air from ozone generator 302 through line 353 and through valve 310. Unlike the first embodiment, however, chemical composition from chemical dispenser 328 is also drawn into venturi 320 through line 367 and through valve 312. Because liquid and gas are both being injected into venturi 320, valves 312 and 310 are used to balance pressures and control flow of such liquid and gas into venturi 320. In one example, valve 310 is rated at 1 psi and valve 312 is rated at ½ psi. An applicable venturi 320 which may be used is a multi-port venturi with a water inlet and outlet through which a flow of water is pumped. Use of a venturi allows the kinetic energy of water being pumped to create a venturi effect and draw ozone-enriched air and chemical composition into the stream of water through injection ports. Water from body of water 270 is pumped along lines 371 and 355 for pumping through venturi 320. One example of a venturi 320, with no intent to limit the invention thereby, is a Mazzei™ Injector Model No. 684, available from Mazzei Injector Corporation, Bakersfield, Calif.

The mixture of ozone, air, chemical composition, and water is sent from venturi 320 and through mixing line 322 to dissolve ozone in the water and to thoroughly treat the water with chemical composition. As previously noted, mixing line 322 allows for a sufficient length of time to achieve maximum diffusion of ozone and chemical composition into the water. In order for ozone dispersion to occur within mixing line 322, mixing line 322 must have a sufficient length, i.e., an ozone contact length. The contact length of the tube may typically be between about 4 feet and about 8 feet. In one example, mixing line 322 is a tube about 4½ feet long, having a diameter of about ¾ inch at the beginning of the line and about 1 inch at the end of the line, and containing five counter-current streams. It is noted that mixing line 322 may have various counter-current streams, optional static mixers or baffles, and need not have a uniform diameter.

After the water is treated in such an environment of high ozone and chemical composition concentrations, the treated water and excess ozone which did not dissolve moves to a separation apparatus 326 so that gas phase and liquid phase materials may be separated. An example of a separation apparatus that may be used is a bubble separator device commonly comprising a hollow cylinder having an upper liquid input port 323, a lower liquid output port 327, and an upper gas vent 325. The bubble separator device reduces the velocities of currents of liquid within the bubble separator to a rate slow enough to allow bubbles of gas to rise to the top of the bubble separator. The bubbles then emit through the gas vent in the ceiling of the bubble separator, rather than continuing to flow downstream through the liquid output. Preferably, the output flow of the bubble separator is adjusted to prevent over filling. Also preferably, a float valve or solenoid-controlled valve 324 is installed with the gas vent to assure that water will not escape from the system through the vent. One example of a separation apparatus 326, with no intent to limit the invention thereby, is piping of about 3 inches in diameter.

Excess ozone which did not dissolve in the water is sent through valve 324 and along line 359 to T-valve 308. Moisture is recirculated back to venturi 320 through line 363 and valve 306. In one example, valve 306 is rated at 3 inches of water. Gas from T-valve 308 is sent along line 361 to chemical dispenser 328, which contains an air reservoir 329 in this embodiment. Air reservoir 329 includes a desiccant or dry filter in one example. Remaining ozone and air from T-valve 308, and any makeup air from air reservoir 329, are then sent through line 351 back to ozone generator 302 for recirculation.

Treated water is discharged from separation apparatus 326 through line 369 and may be routed directly to body of water 270 (e.g., a swimming pool, a whirlpool, a water tank or reservoir, or a hot tub). In addition, a portion of treated water may be split to chemical dispenser apparatus 328 to create a feedback loop for enhanced water treatment. As shown in FIG. 3, an amount of treated water is split and sent through valve 318 and line 365 to chemical dispenser apparatus 328 in order to transport chemical composition to venturi 320 along line 367 to begin the treatment cycle again. In one example, about 0.2 gallons per minute of treated water is sent through check valve 318 and to chemical dispenser apparatus 328 and about 4.3 gallons per minute of treated water is sent back to body of water 270 through line 369. In one example, valve 318 is rated at 2 psi.

It is noted that in this embodiment illustrated in FIG. 3, mixing of ozone, chemical composition, and water to be treated occur on the discharge side of pump 336. It is further noted that lines carrying liquid or gas in the embodiments illustrated in FIGS. 2 and 3 are made of materials so as to be free of leaks and corrosion, such as PVC piping and/or polymer flexible tubing. However, the lines may be made of any applicable material and flexibility desired. Furthermore, it will be apparent to one of ordinary skill in the art that ratings of valves in both embodiments illustrated in FIGS. 2 and 3 may vary depending upon factors such as the size of the body of water to be treated and the pump motor used.

In accordance with the present invention, water from a variety of sources may be treated comprehensively by one system to balance, oxidize, disinfect, and control algae in water with minimal or no venting of ozone. In one example, pH is maintained between about 7.2 and about 7.6, alkalinity is maintained between about 80 and about 120, and bromine residue is kept at about 3 ppm. Furthermore, water treatment system 100 may treat water, for example, at about 4 gallons per minute at an operating pressure of about 8 psi. However, these parameters can be varied as desired and are dependent upon the desired application.

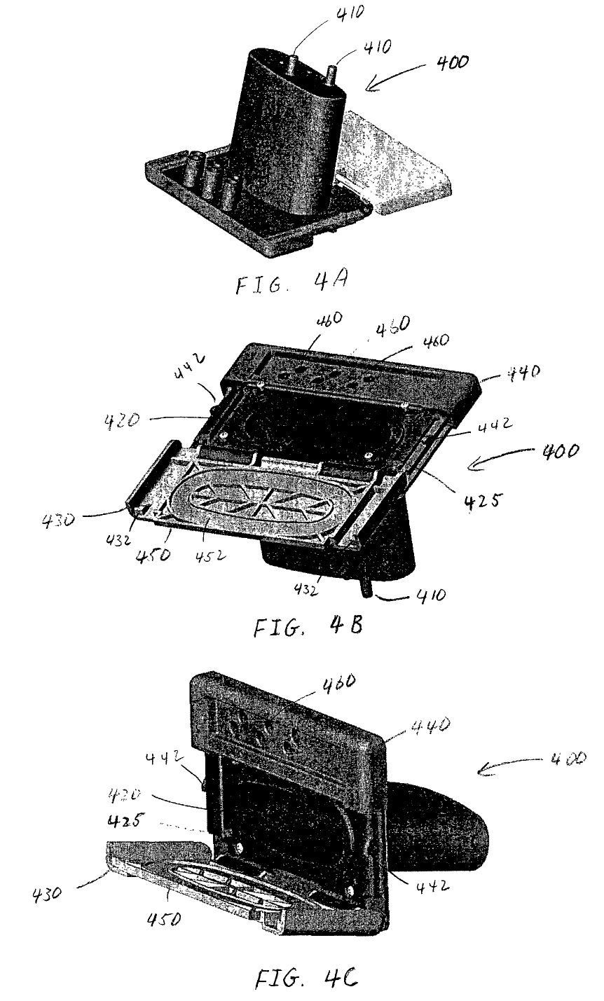

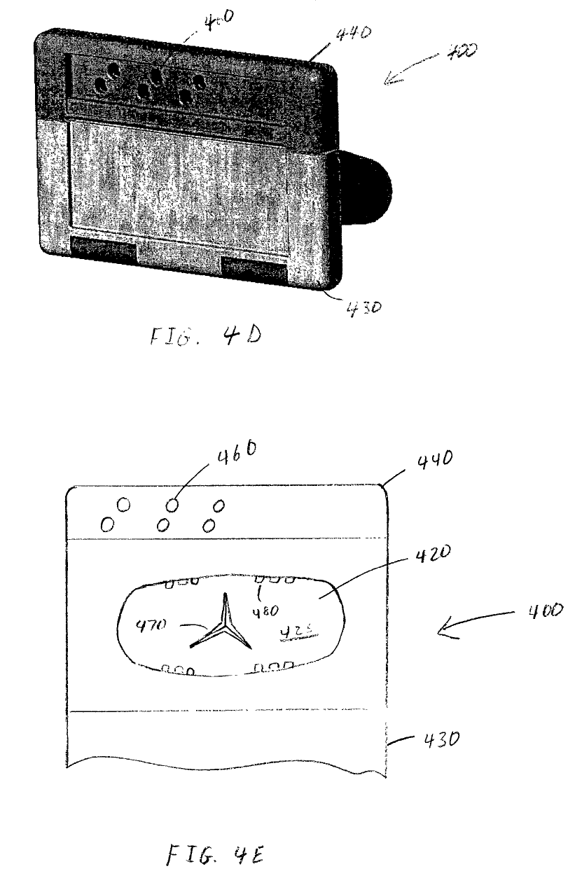

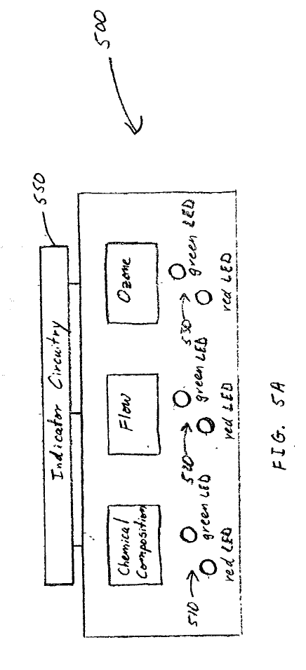

FIGS. 4A-4E illustrate different views of a dispenser housing 400, which is an exemplary embodiment of dispenser housing 142 (FIG. 1) of chemical dispenser apparatus 140 (FIG. 1). In one embodiment, dispenser housing 400 may include ports 410 (FIGS. 4A & 4B) to connect to chemical feed lines 130 (FIG. 1).

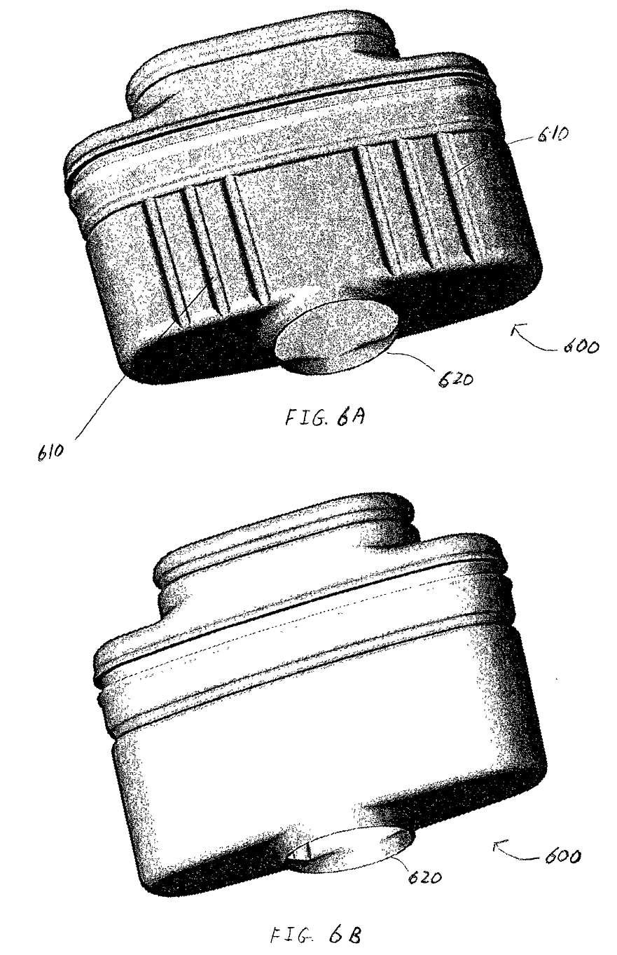

FIGS. 4B, 4C, and 4E show an opening 420 leading to a cavity 425 that can receive a dispenser cartridge 600 (FIGS. 6A & 6B). In one embodiment, a sharp protrusion 470 (FIG. 4E) lies at the bottom of cavity 425 for penetrating through a membrane over an opening 620 (FIGS. 6A & 6B) of dispenser cartridge 600 (FIGS. 6A & 6B) as dispenser cartridge 600 is being inserted into dispenser housing 400. This penetration allows the chemical composition within cartridge 600 to be exposed to water. Also included along the sides of cavity 425 are optional ridges 480 (FIG. 4E) that mate with optional grooves 610 (FIG. 6A) of dispenser cartridge 600.

Sliding section 440 is used to slide over a top portion 450 of flap 430 (i.e., the access door) after flap 430 is placed in a closed position to lock-in dispenser cartridge 600 (FIGS. 6A & 6B) after dispenser cartridge 600 has been fully placed inside cavity 425. Closed dispenser housing 400 is shown in FIG. 4D. Sliding section 440 also includes edge protrusions 442 (FIGS. 4B & 4C) that help open flap 430 once closed. Edge protrusions 442 force flap 430 away from opening 420 by contacting tabs 432 as sliding section 440 is pushed upwards and thus help to break the seal between flap 430 and opening 420 caused by suction from the water treatment system during operation. A gasket 452 also helps to seal flap 430 over opening 420 to prevent leakage.

As further shown in FIGS. 4B-4E, dispenser housing 400 may include openings 460 for an LED system to indicate operation of different functions of the water treatment system, such as for example, the operation of a flowswitch or pump, ozone generator or ozone sensor, and chemical dispenser. A simple circuit may be used to operate the LED system as will be apparent to one of ordinary skill in the art.

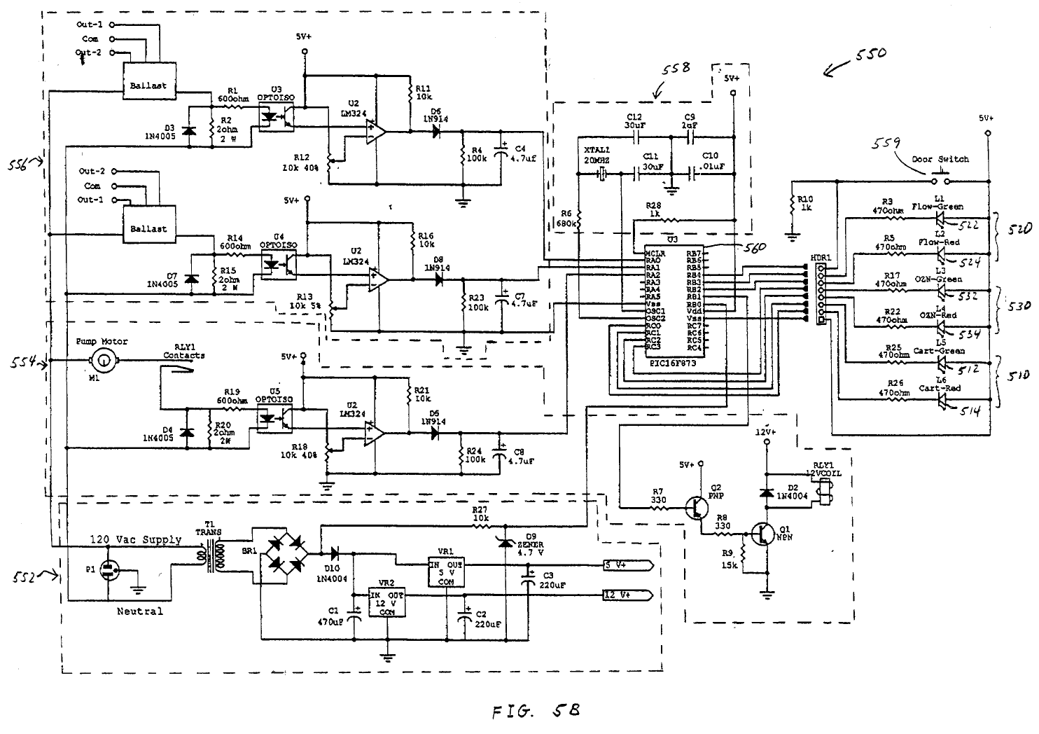

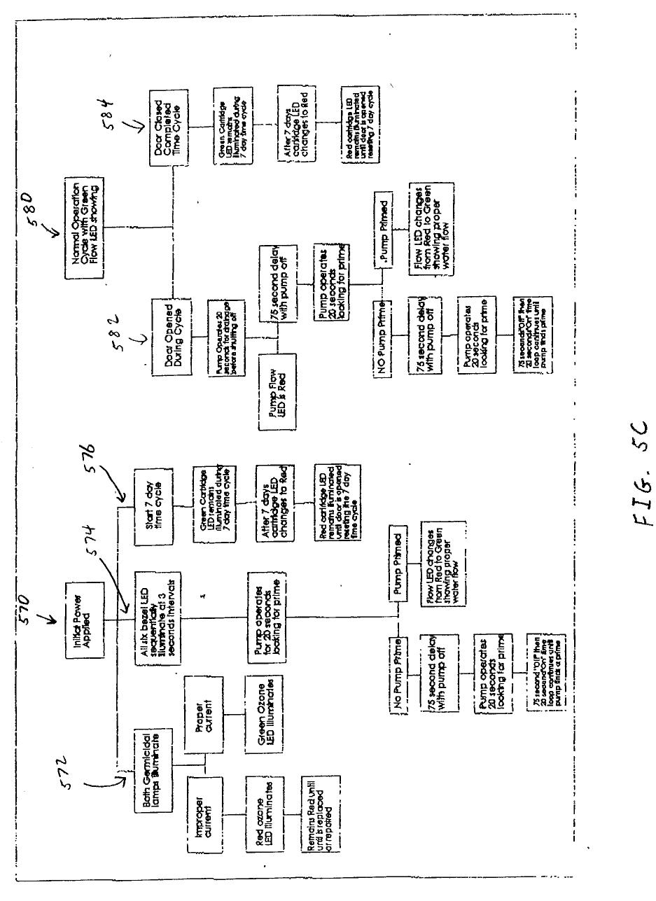

FIGS. 5A-5C illustrate an example of an indicator system, an indicator circuit, and an operational flowchart, respectively, which can be used in accordance with an embodiment of the present invention. FIG. 5A shows an LED system 500 that can be used to indicate operation of the chemical dispenser, pump, and ozone generator. Red and green LEDs 510 indicate whether the chemical composition needs to be replaced (e.g., a lit red LED indicating replacement is required). Operation of LEDs 510 may be based upon a clock signal for replacement on a time basis or a signal from a sensor that measures chemical composition levels in the water being treated. Red and green LEDs 520 indicate water flow through the water treatment system (e.g., a lit red LED indicating water flow has stopped). Operation of LEDs 520 may be based upon a signal from a flowswitch operably connected to the pump or a signal from the pump itself. Red and green LEDs 530 indicate that the ozone generator is functioning properly (e.g., a lit red LED indicating a malfunction). Operation of LEDs 530 may be based upon a signal from an ozone generator or ozone sensor for detecting that a sufficient amount of ozone is being generated to meet required guidelines.

FIG. 5B illustrates an exemplary embodiment of an indicator circuit 550 for LED system 500 (FIG. 5A). Section 552 supplies regulated power (i.e., direct current supply voltages) to indicator circuit 550. Section 554 is used to indicate pump operation, with a green LED 522 being illuminated when the pump is operating and a red LED 524 being illuminated when the pump is idle. Section 556 is used to indicate proper ozone generation by the ozone generator, with a green LED 532 being illuminated when a proper current is detected from the ozone generator lamp and a red LED 534 being illuminated when an improper current is detected from the ozone generator lamp. It is noted that a signal from an ozone sensor detecting amounts of ozone from the ozone generator could also be used to operate LEDs 530. Section 558 is used as a clock/reset mechanism to indicate chemical composition change based upon time, with a green LED 512 being illuminated for a seven day cycle and a red LED 514 being illuminated after a seven day time frame. A signal from a door switch 559 may also be used to reset the LED system clock upon an opening of the dispenser housing access door (indicating chemical composition replacement). It is noted that different time frames or a signal from a chemical composition sensor in the water could also be used to operate LEDs 510. Processor 560 is used to process the signals from sections 554, 556, 558, and door switch 559 in order to operate LEDs 510, 520, and 530.

FIG. 5C illustrates one example of an operational flowchart for the indicator circuit illustrated in FIG. 5B. A flowchart 570 shows the operational flow of the indicator system-when initial power is applied. A path 572 shows the operational flow of the ozone indicator LEDs, a path 574 shows the operational flow of the water flow indicator LEDs, and a path 576 shows the operational flow of the chemical composition indicator LEDs.

A flowchart 580 shows the operational flow of the indicator system during normal operation when the chemical dispenser housing is opened and closed to replace the chemical dispenser cartridge. Path 582 shows the operational flow of the water flow indicator LEDs and path 584 shows the operational flow of the chemical composition indicator LEDs.

FIGS. 6A and 6B illustrate different perspective views of one exemplary embodiment of dispenser cartridge 144 (FIG. 1), which holds the chemical composition that is used to treat water through the system. In one example, dispenser cartridge 600 is capable of being inserted into dispenser housing 400 (FIGS. 4A-4E) through opening 420 (FIGS. 4B,4C,&4E). In one embodiment, as previously noted, dispenser cartridge 600 may include optional grooves 610 to align cartridge 600 into dispenser housing 400 (FIGS. 4A-4E). Alternatively, grooves along dispenser cartridge 600 and ridges along the sides of cavity 425 (FIGS. 4B,4C,&4E) can be switched such that dispenser cartridge 600 includes ridges and cavity 425 includes mating grooves. In one embodiment, as previously noted, chemical composition contained within cartridge 600 is exposed to water by a sharp protrusion 470 (FIG. 4E) within dispenser housing 400 (FIGS. 4A-4E) which penetrates through opening 620 upon insertion of dispenser cartridge 600 into dispenser housing 400 (FIGS. 4A-4E).

The above-described embodiments of the present invention are merely meant to be illustrative and not limiting. Various changes and modifications may be made without departing from this invention in its broader aspects. Therefore, the appended claims encompass all such changes and modifications as fall within the true spirit and scope of this invention.

What is claimed is:

1. A water treatment system, comprising:
an ozone generator adapted to generate ozone;
a mixer, coupled to the ozone generator, adapted to mix the ozone with water to form a mixture; and
a separator, coupled to the ozone generator and the mixer, adapted to separate undissolved ozone from the mixture and return the undissolved ozone to the ozone generator.

2. The system of claim 1, wherein the ozone generator comprises an ultraviolet light ozone generator or a corona discharge ozone generator.

3. The system of claim 2, wherein the ozone generator further comprises an ozone sensor adapted to monitor the amount of the ozone generated by the ozone generator.

4. The system of claim 1, wherein the mixer comprises a venturi and a water line of sufficient length for sufficient mixing of the ozone and the water.

5. The system of claim 4, further comprising a pump, coupled to the separator on a suction side of the pump, adapted to draw the water from the separator.

6. The system of claim 5, further comprising a chemical dispenser, coupled to the mixer and to the pump, adapted to dispense a chemical composition into water being forced through the chemical dispenser by the pump, wherein the mixer is further adapted to mix the chemical composition with the ozone and the water.

7. The system of claim 4, further comprising a pump, coupled to the mixer on a discharge side of the pump, adapted to force the water through the mixer.

8. The system of claim 7, further comprising a chemical dispenser, coupled to the mixer and to the separator, adapted to dispense a chemical composition into water flowing through the chemical dispenser, wherein the mixer is further adapted to mix the chemical composition with the ozone and the water.

9. The system of claim 8, wherein the chemical dispenser further comprises an air reservoir adapted to collect the ozone separated by the separator prior to the ozone returning to the ozone generator.

10. A water treatment system, comprising:
ozone generating means for generating ozone;
mixing means for mixing ozone with water to produce ozonated water, the mixing means being coupled to the ozone generating means; and
separating means for separating undissolved ozone from the ozonated water to return the undissolved ozone to the ozone generating means, the separating means being coupled to the ozone generating means and the mixing means.

11. The system of claim 10, wherein the ozone generating means comprises an ozone sensor adapted to monitor the amount of the ozone generated by the ozone generating means.

12. The system of claim 10, further comprising pumping means for pumping water from the separating means, the pumping means being coupled to the separating means on a suction side of the pumping means.

13. The system of claim 12, further comprising chemical dispensing means for dispensing a chemical composition into water being forced through the chemical dispensing means by the pumping means, the chemical dispensing means being coupled to the mixing means and to the pumping means, wherein the mixing means is further adapted to mix the chemical composition with the ozone and the water.

14. The system of claim 10, further comprising pumping means for pumping water through the mixing means, the pumping means being coupled to the mixing means on a discharge side of the pumping means.

15. The system of claim 14, further comprising chemical dispensing means for dispensing a chemical composition into water flowing through the chemical dispensing means, the chemical dispensing means being coupled to the mixing means and to the separating means, wherein the mixing means is further adapted to mix the chemical composition with the ozone and the water.

16. The system of claim 15, wherein the chemical dispensing means further comprises an air reservoir adapted to collect the undissolved ozone from the separating means prior to the ozone returning to the generating means.

17. A water treatment system, comprising:
a mixing apparatus capable of receiving ozone gas, a chemical composition, and water to be treated to form a mixture;
a separation apparatus operably coupled to the mixing apparatus to separate undissolved ozone gas from the mixture, the undissolved ozone gas being recirculated to prevent ozone venting; and
a pump coupled to the mixing apparatus or the separation apparatus to pull and discharge water mixed with or to be mixed with the ozone gas and the chemical composition.

18. The system of claim 17, wherein the mixing apparatus comprises a venturi.

19. The system of claim 17, wherein the mixing apparatus comprises a T-valve.

20. The system of claim 17, wherein the mixing apparatus is operably coupled to a discharge side of the pump.

21. The system of claim 17, wherein the ozone gas received by the mixing apparatus is provided by an ozone generator.

22. The system of claim 21, wherein the undissolved ozone gas is recirculated to the ozone generator.

23. The system of claim 21, wherein the ozone generator comprises an ultraviolet light ozone generator or a corona discharge ozone generator.

24. The system of claim 17, wherein the chemical composition is capable of oxidizing, disinfecting, balancing, or controlling algae in water.

25. The system of claim 17, wherein the chemical composition comprises:
a buffer compound comprising:
an acidic component; and,
a basic component, wherein the acidic and the basic components are each present in an amount sufficient to provide a molar ratio of the acidic component to the basic component that yields a buffer compound having pH in solution equivalent to the existing pH of the water to be treated; and
a biocide compound present in an amount sufficient to inactivate biological contaminants in the water to be treated.

26. The system of claim 25, wherein the chemical composition further comprises an algicide.

27. The system of claim 25, wherein the chemical composition further comprises a chelating agent.

28. The system of claim 25, wherein the chemical composition further comprises a calcium releasing compound, a scale inhibitor, or a sequestering agent.

29. The system of claim 25, wherein the acidic component is sodium bisulfate, the basic component is sodium bicarbonate, and the molar ratio of sodium bisulfate to sodium bicarbonate is about 0.26 to about 0.14, corresponding to the buffer compound pH in solution from about 6.8 to about 7.2.

30. The system of claim 25, wherein the biocide compound is ammonium chloride, ammonium bromide, or sodium bromide.

31. The system of claim 17, wherein the chemical composition is dispensed to the mixing apparatus by a chemical dispenser comprising a dispenser housing and a dispenser cartridge

32. The system of claim 31, wherein the dispenser housing is capable of receiving the dispenser cartridge.

33. The system of claim 31, wherein the dispenser cartridge stores the chemical composition.

34. The system of claim 17, wherein the separation apparatus is operably coupled to a suction side of the pump.

35. A method of treating water, comprising:
generating ozone gas;
dispensing a chemical composition;
mixing the generated ozone gas and the dispensed chemical composition with water to form a mixture;
separating undissolved ozone gas from the mixture; and
recirculating the undissolved ozone gas to prevent ozone venting.

36. The method of claim 35, wherein the chemical composition comprises:
a buffer compound comprising:
an acidic component; and,
a basic component, wherein the acidic and the basic components are each present in an amount sufficient to provide a molar ratio of the acidic component to the basic component that yields a buffer compound having pH in solution equivalent to the existing pH of the water to be treated; and
a biocide compound present in an amount sufficient to inactivate biological contaminants in the water to be treated.

37. The method of claim 35, wherein the mixing occurs on a suction side of a pump.

38. The method of claim 35, wherein the mixing occurs on a discharge side of a pump.
